(19) United States
(12) Patent Application Publication
(10) Pub. No.: US 2026/0199925 A1
(43) Pub. Date: Jul. 16, 2026

(54) Cigar Glue Dispenser with Integrated Brush and Mixing Mechanism

(71) Applicant: Yoav Aner, Berlin (DE)

(72) Inventor: Yoav Aner, Berlin (DE)

(21) Appl. No.: 19/344,500

(22) Filed: Sep. 29, 2025

Related U.S. Application Data
(60) Provisional application No. 63/709,539, filed on Oct. 21, 2024.

(51) Int. Cl. B05C 1/02; A24C 1/34; B05C 11/10; C09J 105/00

(52) U.S. Cl. CPC B05C 1/02; A24C 1/34; B05C 11/10; C09J 105/00

(57) ABSTRACT

Embodiments of the present invention comprise a device with a casing defining a glue chamber. The glue chamber may contain a glue that is dispensed from the glue chamber, through a device opening in a removable applicator tip, and onto an external surface such as a cigar. A knob may be threadedly engaged with a plunger screw such that when the knob is rotated, the plunger screw is advanced through the casing to push the glue through the glue chamber and out of the device via the device opening. A ball valve may be configured in the applicator tip and may provide an airtight seal for the device. A knob lock may mate with the knob to allow the knob to be rotated in only one direction, thereby preventing the plunger screw from being retracted and pulling air into the glue chamber.

### CROSS-REFERENCE TO RELATED APPLICATIONS

This application claims priority from U.S. Provisional Patent Application No. 63/709,539, filed on Oct. 21, 2024, which is hereby incorporated by reference.

### BACKGROUND OF THE INVENTION

The present invention relates to the field of cigar accessories, particularly focusing on tools used to repair damaged cigars. The present invention may also relate to constructing and/or repairing other smokeable articles such as but not limited to cigars, cigarettes, cigarillos, or marijuana cigarettes/cigarillos.

Cigar smoking is a cherished tradition among enthusiasts, representing not only a leisurely activity but also a refined cultural experience. However, cigar smokers often encounter a recurring issue: cracked or split cigar wrappers. These damages can significantly affect the overall smoking experience by leading to uneven burns, compromised airflow or expansion of the binder and filler that can ruin the whole cigar. Repairing cigars typically requires the use of cigar glue, but current methods involve separate glue containers and application brushes, which can be messy and inefficient. They are also very inconvenient to use “on the go”. A more streamlined, user-friendly solution is necessary to address these inconveniences.

The condition of a cigar's wrapper is crucial to the overall smoking experience. Even small cracks can lead to an uneven burn or improper airflow, diminishing the enjoyment of the cigar, or rending it completely unsmokeable. Traditional solutions for repairing cigars can be cumbersome, as users must juggle a separate glue bottle and application brush, which can result in spills, over-application, or contamination. Furthermore, exposure to air and residues from the brush can spoil the glue over time, rendering it ineffective, or worse, contaminating it with bacteria or fungi, which can be hazardous to the smoker of the cigar.

The cigar industry is a thriving market, valued at over $10 billion globally, with a growing premium cigar segment that caters to discerning smokers. Premium cigars typically range from $8 to $30 each, making it important for consumers to maintain their cigars in optimal condition. Surveys show that nearly 40% of cigar smokers have experienced issues with cracked or split wrappers, which are particularly common in dry climates or due to improper storage. Despite the market size and the frequency of these issues, there has been little innovation in cigar repair tools, leading to dissatisfaction among 20-30% of users. These cigar smokers report frustrations with current glue solutions, citing messiness, spoilage from air exposure, and unwanted flavor alterations. The lack of reliable, easy-to-use tools has created a gap in the market.

There have been some efforts to innovate in the cigar repair market, mostly focused on improving glue formulations by using food-safe ingredients. Some manufacturers offer small bottles of adhesive glue specifically for cigars, often paired with separate application brushes. While these products are an improvement over generic household adhesives, they still suffer from issues such as air exposure, which leads to glue drying out or losing effectiveness over time. Worse, it can cause contamination and introduction of bacteria and fungi into the glue which can be harmful to the smoker of the cigar. Sedimentation of glue ingredients remains another challenge, with users having to shake or stir the glue regularly to ensure proper consistency.

Despite the availability of specialized cigar glues, users continue to experience several significant drawbacks. First, applying glue from a bottle with a separate brush can be a messy process, often resulting in drips and uneven application. Air exposure is another persistent issue, as the glue in most current products dries out prematurely due to repeated opening and closing of the container. This not only shortens the shelf life of the product but also decreases the quality of the glue over time and can cause contamination. Additionally, the settling of ingredients in the glue can cause inconsistency, requiring users to manually shake or stir the bottle to get the glue ready for use. Many cigar enthusiasts are also concerned that some glues may alter the taste of the cigar, making them hesitant to use them regularly. The lack of precision when applying glue with a separate brush is another common complaint, as users struggle to apply just the right amount without making a mess.

### SUMMARY OF THE INVENTION

Embodiments of the present invention may comprise a device with a casing defining a glue chamber. The glue chamber may contain a glue. The glue may be a liquid adhesive. The glue may be food-safe, meaning it does not contain chemicals deemed harmful or toxic to humans. The glue may be made entirely of natural ingredients, meaning ingredients obtained directly from their natural sources without any additives that are not obtained directly from their natural sources. The glue may dry in 10 minutes or less after being applied to an external surface. In some embodiments, the glue may dry in 5 minutes or less after being applied to an external surface. The glue may be orderless and tasteless so that when it is applied to a smoking article it does not affect the taste or aroma of the smoking article.

The glue may comprise a mixture of distilled water, rice syrup, and/or at least one natural gum. The glue may also comprise a water-soluble cellulose. In some embodiments, different natural syrups other than rice syrup may be used. The syrup may provide an optimal viscosity for the glue so that the glue is easily applied to an external surface and so that the glue dries quickly. The at least one natural gum may be selected from a group comprising acacia gum and xanthan gum. The at least one natural gum may alternatively be any natural gum and is not limited to acacia gum or xanthan gum. The at least one natural gum may provide the adhesive properties of the glue.

In some embodiments, the glue may comprise a preservative. The preservative may be obtained directly from a natural source without additives not obtained from their natural sources. Examples of the preservative include but are not limited to salt, sugar, vinegar, rosemary extract, citric acid, sorbic acid, or combinations thereof. The preservative may be chosen so that when the preservative is mixed with the rest of the glue, the glue retains its odorless and tasteless properties. The preservative may allow for the glue to remain in the glue chamber of the device without developing unwanted odors, developing unwanted flavors, or attracting unwanted microbes. The preservative may further allow the glue to remain applied to an external surface without developing unwanted odors, developing unwanted flavors, or attracting unwanted microbes.

The glue chamber may also contain a mixing ball. The mixing ball may be made of materials including but not limited to glass, stainless steel, aluminum, or polyethylene. Glass may be the preferred material of the mixing ball since it is heavier than plastic and does not rust. The mixing ball may be configured to mix the glue within the glue chamber when the casing of the device is agitated. The casing may be agitated by shaking the device, spinning the device, rotating the device, or otherwise moving the device in a manner that causes the mixing ball to move within the glue chamber relative to the rest of the glue chamber. Since the various ingredients of the glue may have different densities and viscosities, agitating the casing to cause the mixing ball to mix the glue allows the glue to maintain a uniform consistency, which allows the glue to function optimally as an adhesive when applied to an external surface. Agitating the casing to cause the mixing ball to mix the glue may also prevent sediment from developing in the glue chamber, which further allows the glue to function optimally as an adhesive when applied to an external surface.

An applicator tip may be removably connected to the casing. The applicator tip may comprise a device opening through which glue may flow when exiting the device to be applied to an external surface. A ball valve may be configured within the applicator tip. The ball valve may comprise a ball valve ball and a ball valve spring. The ball valve ball may be made of materials including but not limited to glass, stainless steel, aluminum, or polyethylene. Glass may be the preferred material of the ball valve ball since it is heavier than plastic and does not rust. The ball valve spring may be a helical compression spring that is configured to bias the ball valve ball towards a glue chamber opening of the glue chamber to cover the glue chamber opening. In some embodiments, the glue chamber opening may comprise a glue chamber tip. The glue chamber tip may be shaped as a nozzle that diminishes in diameter as the glue chamber tip extends away from the rest of the glue chamber and towards the device opening. In such embodiments, the ball valve ball may be configured to cover the portion of the glue chamber tip with the smallest diameter.

A plurality of bristles may be configured on the applicator tip at the device opening and may extend away from the rest of the applicator tip. The plurality of bristles may be made of a natural material such as but not limited to horsehair. The plurality of bristles may be permanently configured on the applicator tip and may therefore negate the need for a separate brush to be used when applying glue from the device to an external surface. The plurality of bristles may be used to spread the glue over an external surface when the glue is applied to the external surface.

The plurality of bristles may alternatively be made of a synthetic material. In some embodiments of the present invention, a foam or plastic tip may extend from the applicator tip instead of the plurality of bristles. In these embodiments, the foam tip or plastic tip may be monolithic. The foam tip or plastic tip may be used for the same purpose as the plurality of bristles.

A knob may be partially inserted into the casing. The knob may be partially inserted into the casing at an end of the casing opposite the applicator tip. The knob may have knob teeth that may mate with knob lock teeth of a corresponding knob lock. The knob lock may be configured concentrically around a plunger screw. The plunger screw may be threadedly engaged with the knob such that rotating the knob causes the plunger screw to advance through the casing and to push the glue towards the glue chamber opening. The mating of the knob lock teeth and the knob teeth may allow the knob to be rotated in only one direction (i.e. either only clockwise or only counterclockwise) such that the plunger may only be advanced through the casing and not retraced through the casing. For the purposes of this disclosure, the plunger screw is “advanced” through the casing when it is translated towards the device opening.

Advancing the plunger screw through the casing may cause glue to flow through the glue chamber towards the glue chamber opening. Advancing the plunger screw through the casing may also decrease the volume in the glue chamber between the glue chamber opening and the plunger screw, thereby increasing the pressure in the glue chamber. This increase in pressure may cause the ball valve ball to translate away from the glue chamber opening, thereby compressing the ball valve spring. When the ball valve ball is translated away from the glue chamber opening, some of the glue may be allowed to exit the glue chamber via the glue chamber opening. The some of the glue may then enter the applicator tip and then exit the device via the device opening configured in the applicator tip.

Halting the rotation of the knob may halt the advance of the plunger screw through the casing, which may cause a decrease in the flow of glue towards the glue chamber opening. This decrease in the flow of glue towards the glue chamber opening may allow the ball valve spring to expand, thereby biasing the ball valve ball towards the glue chamber opening to cover the glue chamber opening. Covering the glue chamber opening with the ball valve ball when no glue is existing the glue chamber prevents air from entering the glue chamber and contaminating/drying out the glue.

Advancing the plunger screw through the casing may also cause the mixing ball to mix the glue by moving the mixing ball relative to the rest of the glue chamber. Advancing the plunger screw through the casing may also dispense the glue from the glue chamber at a controlled rate. This is in contrary to other devices in which glue is poured from a container using gravity, squeezed from a container by compressing the container walls, or removed from a container by dipping a brush into the container. By using a threaded engagement to advance the plunger screw to dispense glue, the glue may only be dispensed from the glue chamber at the rate at which the plunger screw advances, which may be controlled by the rate at which the knob is rotated.

When glue exist the device, the glue may be applied to an external surface. The external surface may be a smoking article, which may be any article designed to be burned such that the ensuing smoke is tasted or inhaled by a user. Examples of smoking articles may include but are not limited to cigars, cigarettes, cigarillos, marijuana cigarettes, and marijuana cigarillos. In preferred embodiments of the present invention, the smoking article is a cigar. The glue may be applied to the smoking article to repair a break, rip, or tear in the smoking article. For example, the outer leaf of a cigar may have a tear that affects the integrity and smokeability of the cigar. Glue from the glue chamber of the device may be applied to the outer leaf to repair the tear, thereby maintaining the integrity and smokeability of the cigar. The glue may be applied uniformly over the cigar using the plurality of bristles attached to the applicator tip.

The external surface may be any surface of a smokeable article. For example, the external surface may be the outer surface of an outer wrap or outer leaf of a smokeable article. Alternatively, the external surface may be the inner surface of an outer wrap or outer leaf of a smokeable article. This allows the device to be used for constructing a smokeable article by applying glue to the inside surface of an outer leaf/wrap and pressing the inside surface of the outer leaf/wrap against the outside surface of the outer leaf/wrap.

Removably configuring the applicator tip to the casing and covering the device opening with the ball valve ball may cause the glue chamber to be airtight such that no air may enter or exit the glue chamber. This prevents the glue in the glue chamber from drying out and losing its ability to flow through the device opening. Allowing the knob to only be rotated in one direction may further cause the glue chamber to be airtight since the plunger screw is unable to be retracted such that air would be drawn into the glue chamber via the device opening.

A cap may be removably configured over the applicator tip. The cap may further allow the glue chamber to be airtight by forming an airtight connection over the applicator tip, thereby not allowing air to enter the device opening. The airtight connection over the applicator tip may also prevent air or other contamination from reaching the plurality of bristles, which prevents any glue on the plurality of bristles from drying and stiffening the plurality of bristles.

A hinge may connect the cap and the casing. The hinge may allow the cap to rotate towards and away from the applicator tip, thereby allowing the cap to be removably configured over the applicator tip. The cap may be made of a flexible material such as but not limited to silicone, polyethylene, or ethylene vinyl acetate. The flexible nature of the cap allows it to temporarily deform when configured over the applicator tip, thereby forming an airtight seal.

The device may have a device length when the device is fully assembled. When the device is fully assembled, the knob, knob lock, and plunger screw may be configured at one end of the casing, and the applicator tip and ball valve may be configured at the other end of the casing. In some embodiments, the cap may also be removably configured over the applicator tip when the device is fully assembled. The device length may be in the range of 100 mm to 200 mm, inclusive. The device may also have a device diameter measured at the widest point of the casing. The device diameter may be in the range of 10 mm to 30 mm, inclusive. Notwithstanding the previously mentioned possible device length and device diameter measurements, the ratio of the device length to the device diameter may be in the range of 20:1 to 10:3, inclusive. These dimensions and ratios are designed to give the device an overall shape and size similar to that of a writing instrument such as a marker or a pen. This allows for familiar, ergonomic handling of the device by a user.

### BRIEF DESCRIPTION OF DRAWINGS

FIG. 1 shows a front view of a device according to embodiments of the present invention.

FIG. 2 shows a front exploded view of a device according to embodiments of the present invention.

FIG. 3 shows a front view of certain components of a device according to embodiments of the present invention.

FIG. 4 shows illustrated steps of a method for using the device of the preceding figures.

### DETAILED DESCRIPTION OF THE INVENTION

The description provided herein describes example embodiments of the present invention and is not intended to limit the present invention to any particular embodiment, feature, component, material, chemical composition, use, functionality, method steps, or any other property. Furthermore, the drawings provided herein show example embodiments of the present invention and are not intended to limit the present invention to any particular embodiment, feature, component, material, chemical composition, use, functionality, method steps, or any other property.

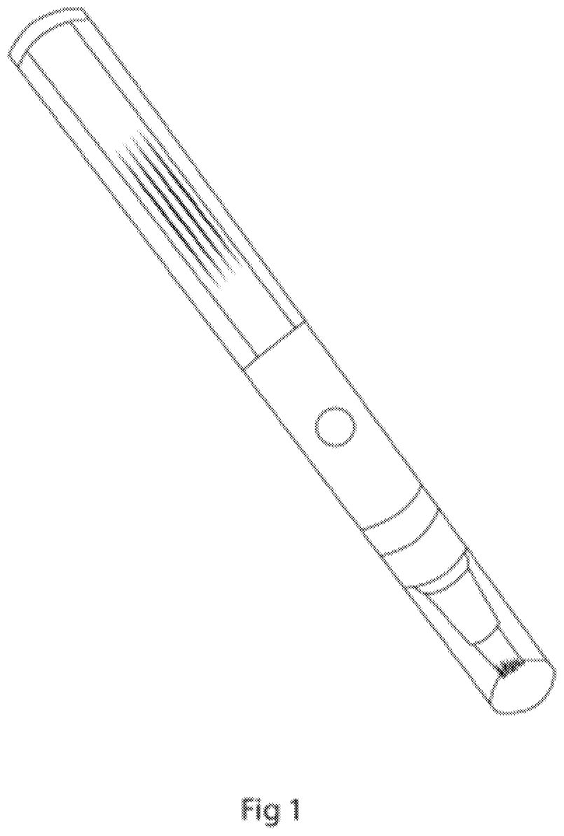

As shown in FIG. 1, a device 10 has a casing 20 that defines a glue chamber 24. Glue 28 is contained within the glue chamber 24. A mixing ball 26 is also contained within the glue chamber 24. When the casing 20 is agitated such as but not limited to being shaken, spun, rotated, or a combination thereof, the mixing ball 26 may move about the glue chamber 24 in a pattern that mixes the glue 28.

An applicator tip 30 is removably connected to one end of the casing 20. The applicator tip 30 has an opening that defines a device opening 16 through which glue 28 may exit when the applicator tip 30 is removably connected to the housing 20. A plurality of bristles 38 protrude from the device opening 16 in a direction away from the casing 20. A cap 55 is removably configured over the applicator tip 30 to prevent contamination of the applicator tip 30, the plurality of bristles 38, or the glue 28 when the device 10 is not in use. The cap 55 may be transparent such that one can view the applicator tip 30 when the cap 55 is removably configured over the applicator tip 30. The cap 55 is connected to the casing 20 via a hinge 57 which allows the cap 55 to be rotated towards or away from the applicator tip 30, thereby being removably configured over the applicator tip 30. The cap 55 may form an airtight seal with the casing 20 when it is removably configured over the applicator tip 30.

A knob 40 is removably connected to the casing 20 at an end of the casing opposite where the applicator tip 30 is removably connected. When the device 10 is fully assembled, a device length 12 may extend from the end of the knob 40 that is not connected to the casing 20 to the end of the applicator tip 30 (including the plurality of bristles 38) that is not connected to the casing 20. When the cap 55 is removably configured over the applicator tip 30, the device length 12 may extend from the end of the knob 40 that is not connected to the casing 20 to the end of the cap 55 configured furthest from the casing. A device diameter 14 is measured at the widest part of the device 10, which may be the widest part of the casing 20 or the widest part of the knob 40. In embodiments wherein the casing 20 and/or knob 40 are cylindrical, the device diameter 14 may be the diameter of the casing 20 and/or knob 40.

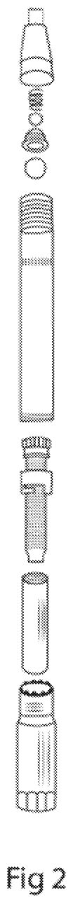

As shown in FIG. 2, the knob 40 has knob threads 41 into which a plunger screw 44 is threaded. The knob threads 41 are shown in FIG. 2 as a separate cylindrical component that fits concentrically into the rest of the knob 40. In some embodiments, this separate cylindrical component may be removably configured into the rest of the knob 40. In other embodiments, this separate cylindrical component may be permanently mated with the rest of the knob 40 by methods such as but not limited to adhesives or a press fit. In other embodiments, the knob threads 41 may be formed as part of the knob 40 itself and not as a separate cylindrical component.

When the knob 40 is rotated, the mating of the knob threads 41 and the threads of the plunger screw 44 cause the plunger screw 44 to advance within the casing 20 towards the applicator tip 30. The end of the plunger screw 44 configured closest to the applicator tip 30 may extend the entire inner diameter of the casing 20 such that all glue configured in the casing 20 is pushed towards the applicator tip 30 when the plunger screw 44 advances towards the applicator tip 30. Some of the glue then exits the device 10 through the device opening 16 in the applicator tip 30. The applicator tip 30 may be shaped as a nozzle with a diameter that diminishes as the applicator tip 30 extends away from the casing 20. This regulates the volume of glue that exits the device 10 at a given time.

A ball valve 32 is configured within the applicator tip 30. The ball valve 32 comprises a ball valve ball 34 and a ball valve spring 36 that biases the ball valve ball 34 towards a glue chamber opening 25 of the glue chamber 24 opening 25 to cover the glue chamber opening 25. One end of the ball valve spring 36 may contact the ball valve ball 34, and the other end of the ball valve spring 36 may contact the rest of the applicator tip 30. Advancing the plunger screw 44 through the casing 20 may cause glue to flow through the glue chamber 24 towards the glue chamber opening 25. Advancing the plunger screw 44 through the casing 20 may also decrease the volume in the glue chamber 24 between the glue chamber opening 25 and the plunger screw 44, thereby increasing the pressure in the glue chamber 24. This increase in pressure may cause the ball valve ball 34 to translate away from the glue chamber opening 25, thereby compressing the ball valve spring 36. When the ball valve ball 34 is translated away from the glue chamber opening 25, some of the glue may be allowed to exit the glue chamber 24 via the glue chamber opening 25. The some of the glue may then enter the applicator tip 30 and then exit the device 10 via the device opening 16 configured in the applicator tip 30.

Halting the rotation of the knob 40 may halt the advance of the plunger screw 44 through the casing 20, which may cause a decrease in the flow of glue towards the glue chamber opening 25. This decrease in the flow of glue towards the glue chamber opening 24 may allow the ball valve spring 36 to expand, thereby biasing the ball valve ball 34 towards the glue chamber opening 25 to cover the glue chamber opening 25. Covering the glue chamber opening 25 with the ball valve ball 34 when no glue is existing the glue chamber 24 prevents air from entering the glue chamber 24 and contaminating/drying out the glue.

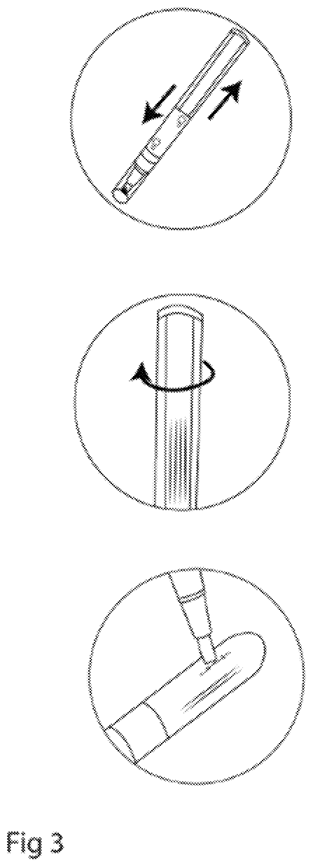

Knob teeth 42 protrude from an end of the knob that may be inserted into the casing 20 of the device 10. The knob teeth 42 mate with corresponding knob lock teeth 52 of a knob lock 50. The knob lock is configured concentrically around the plunger screw 44 and may move freely along a longitudinal axis of the plunger screw 44. The knob lock teeth 52 may be multiple serrated protrusions as shown in FIG. 3, or alternatively may be one or more non-serrated protrusions as shown in FIG. 2. The knob lock teeth 52 mate with the knob teeth 42 to allow the knob to be rotated only in one direction. This is described further in the ensuing description of FIG. 3.

As shown in FIG. 3, each of the knob teeth 42 and knob lock teeth 52 are serrated teeth with a stop portion 46 and a slide portion 47. The stop portion 46 and slide portion 47 are labeled on one knob tooth 42 in FIG. 3 for conciseness, though it shall be understood that these portions apply to all knob teeth 42 and knob lock teeth 52 shown in FIG. 3. The knob teeth 42 and knob lock teeth 52 are mated such that the stop portions 46 of the knob teeth 42 contact corresponding stop portions of the 46 of the knob lock teeth 52, and such that the slide portions 47 of the knob teeth 42 contact corresponding slide portions 47 of the knob lock teeth 52.

The stop portions 46 of the knob teeth 42 and knob lock teeth 52 may be configured perpendicular to a direction of rotation of the knob 40 (to the right of the page as shown in FIG. 3) such that neither the knob 40 nor the knob lock 50 yield when the knob 40 is rotated in a direction that compresses the stop portions 46 of the knob teeth 42 and knob lock teeth 52 (to the left of the page as shown in FIG. 3). The slide portions 47 of the knob teeth 42 and knob lock teeth 52 may be configured at a non-perpendicular angle to a direction of rotation of the knob 40 such that the knob 40 and knob lock 50 slide relative to one another when the knob 40 is rotated in a direction that compresses the slide portions 47 of the knob teeth 42 and knob lock teeth 52 (to the right of the page as shown by the arrows in FIG. 3). This design allows the knob 40 to be rotated in only one direction (to the right of the page as shown by the arrows in FIG. 3), which allows the plunger screw 44 to only advance through the casing and not retract through the casing. This prevents air from entering the glue chamber and contaminating or drying out the glue. In order to retract the plunger screw 44, the device 10 may be disassembled and the plunger screw 44 may be threaded further into the knob 40.

The knob lock 50 may have a limited range of motion along a longitudinal axis of the plunger screw 44. This limited range of motion may allow the knob lock 50 to effectively stop the knob 40 from rotating in a direction that would retract the plungers screw 44 through the casing. This limited range of motion may be achieved by features such as but not limited to a spring that biases the knob lock 50 towards the knob 40 or protrusions inside the casing that contact the knob lock 50 and prevent the knob lock 50 from traveling a certain distance away from the knob 40.

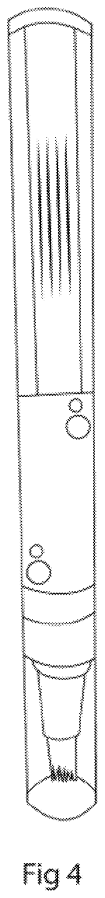

As shown in FIG. 4, a method 11 for using the device 10 shown in FIGS. 1-3 includes shaking the device 10, twisting (i.e. rotating) the knob 40, and applying the glue 28 to an external surface 60. Shaking the device 10 may agitate the casing 20, which may cause the mixing ball to move within the glue chamber 24 and thereby mix the glue 28 configured within the glue chamber 28. The glue 28 may comprise multiple components with different viscosities, and therefore mixing the glue 28 may be essential in ensuring proper adhesive properties of the glue 28 when applied to the external surface 60. Twisting the knob 40 may cause the plunger screw (not shown in FIG. 4) to advance through the casing 20, thereby moving some of the glue 28 from the glue chamber 24 to the applicator tip 30 and out of the applicator tip 30 via the device opening.

The external surface 60 shown in FIG. 4 is a smoking article, and is more specifically a cigar. The glue 28 is used as an adhesive to repair a tear in the outer leaf of the cigar. The plurality of bristles 38 of the applicator tip 30 are used to spread the glue 28 on the external surface 60 so the glue 28 is applied uniformly, ensuring optimal functionality of the cigar when the tear in its outer leaf is repaired. If the glue 28 were not applied uniformly, parts of the tear may not be fully repaired and other parts of the tear may have large clumps of glue. The large clumps of glue may burn unevenly, causing a non-optimal smoking experience. The large clumps of glue may also provide a non-optimal tactile feel for a user when handling the cigar.

What is claimed is:

1. A device comprising:
a casing;
a glue chamber defined by the casing and comprising a glue chamber opening;
a glue contained within the glue chamber;
a mixing ball configured within the glue chamber and configured to mix the glue when the casing is agitated;
an applicator tip removably connected to the casing, the applicator tip comprising a device opening;
a device length measured when the device is fully assembled;
a device diameter measured at the widest point of the casing;
a ball valve configured within the applicator tip, the ball valve comprising:
a ball valve ball;
a ball valve spring configured to bias the ball valve ball towards the glue chamber opening to cover the glue chamber opening;
a knob partially inserted into the casing, the knob comprising knob teeth;
a plunger screw threadedly engaged with the knob whereby rotating the knob causes the plunger screw to advance through the casing and to push the glue toward the glue chamber opening; and
a knob lock comprising knob lock teeth that mate with the knob teeth, whereby the mating between the knob lock teeth and the knob teeth allows the knob to be rotated only in one direction,
wherein pressure in the glue chamber caused by glue flowing towards the glue chamber opening causes the ball valve to translate away from the glue chamber opening such that the glue chamber opening is uncovered, wherein glue is allowed to exit the glue chamber via the glue chamber opening and subsequently exit the device via the device opening,
wherein a decrease in flow of the glue towards the glue chamber opening allows the ball valve spring to expand to bias the ball valve ball towards the glue chamber opening to cover the glue chamber opening with the ball valve ball.

2. The device of claim 1, wherein the applicator tip comprises a plurality of bristles.

3. The device of claim 1, wherein the mixing ball is made of glass.

4. The device of claim 1, wherein the ball valve ball is made of glass.

5. The device of claim 1, further comprising a cap removably configured over the applicator tip.

6. The device of claim 5, further comprising a hinge connected to the casing and the cap, the hinge being configured to allow the cap to rotate towards and away from the applicator tip and thereby be removably configured over the applicator tip.

7. The device of claim 1, wherein the glue comprises:
distilled water; and
at least one natural gum.

8. The device of claim 7, wherein the at least one natural gum is selected from a group comprising:
acacia gum; and
xanthan gum.

9. The device of claim 1, wherein the glue further comprises a preservative.

10. The device of claim 1, wherein the device length is in the range of 100 mm to 200 mm, inclusive.

11. The device of claim 1, wherein the device diameter is in the range of 10 mm to 30 mm, inclusive.

12. The device of claim 1, wherein the ratio of device length to device diameter is in the range of 20:1 to 10:3, inclusive.

13. The device of claim 1, wherein the glue chamber is configured to be airtight by removably connecting the applicator tip to the casing and by covering the device opening with the ball valve ball.

14. The device of claim 1, wherein the knob is partially inserted into the casing at an end opposite the applicator tip.

15. The device of claim 1, wherein the knob lock is configured concentrically around the plunger screw.

16. The device of claim 1, wherein the glue is applied to an external surface upon exiting the device.

17. The device of claim 16, wherein the external surface is a smoking article.

18. The device of claim 17, wherein the external surface is a cigar.

19. The device of claim 1, wherein the glue chamber opening comprises a nozzle-shaped glue chamber tip that diminishes in diameter as the glue chamber tip extends towards the device opening,
wherein the ball valve ball covers the portion of the glue chamber tip with the smallest diameter.

20. The device of claim 1, wherein the mixing ball is configured to mix the glue when the plunger screw is advanced through the casing.
